(19) United States
(12) Patent Application Publication
(10) Pub. No.: US 2021/0239066 A1
(43) Pub. Date: Aug. 5, 2021

(54) EVAPORATIVE FUEL PROCESSING DEVICE

(71) Applicant: HAMANAKODENSO CO., LTD., Kosai-city (JP)

(72) Inventors: Kimio UCHIDA, Kariya-city (JP); Hirofumi ONODERA, Kariya-city (JP)

(21) Appl. No.: 17/160,682

(22) Filed: Jan. 28, 2021

(30) Foreign Application Priority Data
Jan. 30, 2020 (JP) 2020-014103

(51) Int. Cl. F02D 41/24; F02M 25/08; F02D 41/00

(52) U.S. Cl. CPC F02D 41/2464; F02M 25/0836; F02D 2200/0602; F02D 41/003; F02D 41/2422

(57) ABSTRACT

A control device transmits an opening degree command amount to an actuator to command an opening degree of a sealing valve. The control device learns a valve opening start amount in a learning operation based on the opening degree command amount when pressure of vapor-phase gas in a fuel tank starts to decrease in response to the opening degree command amount that gradually increases from zero. The control device sets a valve opening threshold, which is for determining that pressure of vapor-phase gas has started to decrease, based on a before-learning pressure, which is pressure of vapor-phase gas before the learning operation is started. The control device determines the opening degree command amount based on the valve opening start amount unit when causing the sealing valve to open to perform a vapor operation or a purge operation.

### CROSS REFERENCE TO RELATED APPLICATION

The present application claims the benefit of priority from Japanese Patent Application No. 2020-014103 filed on Jan. 30, 2020. The entire disclosures of all of the above applications are incorporated herein by reference.

### TECHNICAL FIELD

The present disclosure relates to an evaporative fuel processing device provided in a vehicle.

### BACKGROUND

In a vehicle having an internal combustion engine, liquid fuel is stored in a fuel tank and is to be used for the internal combustion engine. The gas in the fuel tank exerts pressure such as vapor pressure of the evaporated fuel according to the temperature. When refueling the fuel tank, in order not to release the evaporated fuel to the outside, an evaporative fuel processing device having a canister configured to adsorb the evaporated fuel is used.

### SUMMARY

According to an aspect of the present disclosure, an evaporated fuel processing device is provided in a vehicle, which includes an internal combustion engine and a fuel tank, for processing evaporated fuel that is fuel evaporated in the fuel tank. The evaporated fuel processing device comprises a canister including an adsorbent for adsorbing evaporated fuel. The evaporated fuel processing device further comprises a sealing valve provided in a vapor pipe that connects the fuel tank to the canister, the sealing valve configured to be operated by an actuator to quantitatively adjust an opening degree of the sealing valve to open and close the vapor pipe. The evaporated fuel processing device further comprises a pressure sensor provided in the fuel tank and configured to detect a pressure of vapor-phase gas in the fuel tank. The evaporated fuel processing device further comprises a purge valve provided in a purge pipe connecting the canister to an intake pipe of the internal combustion engine, the purge valve configured to open and close the purge pipe. The evaporated fuel processing device further comprises a control device(5) configured to selectively execute each of a sealing operation to cause the sealing valve to close the vapor pipe to seal the fuel tank, a vapor operation to cause the sealing valve to open the vapor pipe to purge the vapor-phase gas in the fuel tank into the canister, a canister purge operation to cause the purge valve to open the purge pipe to purge a fuel component in the canister into the intake pipe, a purge operation to cause the sealing valve to open the vapor pipe and at the same time to cause the purge valve to open the purge pipe to purge the vapor-phase gas in the fuel tank into the intake pipe by bypassing the canister, and a learning operation to learn an opening degree of the sealing valve during at least one of the vapor operation or the purge operation. The control device includes an opening degree command unit configured to transmit an opening degree command amount, which is for determining the opening degree of the sealing valve, to the actuator, a valve opening start learning unit configured to learn a valve opening start amount in the learning operation based on the opening degree command amount when pressure of the vapor-phase gas starts to decrease in response to the opening degree command amount that gradually increases from zero, and a valve opening threshold set unit configured to set a valve opening threshold, which is for determining that the pressure of the vapor-phase gas has started to decrease, based on a before-learning pressure, which is the pressure of the vapor-phase gas before a time point when the learning operation is started. The control device is configured to determine the opening degree command amount of the opening degree command unit based on the valve opening start amount of the valve opening start learning unit when causing the sealing valve to open to perform the vapor operation or the purge operation.

### BRIEF DESCRIPTION OF THE DRAWINGS

The above and other objects, features and advantages of the present invention will become more apparent from the following detailed description made with reference to the accompanying drawings. In the drawings:

FIG. 1 is an explanatory diagram illustrating a part of a vehicle in which an evaporative fuel processing device according to a first embodiment is disposed;

FIG. 2 is an explanatory diagram schematically showing a control device of the evaporative fuel processing device according to the first embodiment;

FIG. 3 is an explanatory diagram illustrating a sealing valve in a closed position in the evaporative fuel processing device according to the first embodiment;

FIG. 4 is an explanatory diagram showing the sealing valve in an open position in the evaporative fuel processing device according to the first embodiment;

FIG. 5 is a graph showing a relationship between an opening degree command amount from a control device and an opening degree of a sealing valve according to the first embodiment;

FIG. 6 is a graph showing a relationship map between a pressure of a the vapor-phase gas and a valve opening start amount according to the first embodiment;

FIG. 7 is a graph for comparison and showing a relationship between the opening degree of the sealing valve and the valve opening start amount, when the valve opening threshold value from the control device is set to a constant value regardless of a pressure region of the vapor-phase gas, according to the first embodiment;

FIG. 8 is a graph showing a relationship between the opening degree of the sealing valve and the valve opening start amount, when the valve opening threshold value from the control device is a variable value according to the pressure region of the vapor-phase gas, according to the first embodiment;

FIG. 9 is a graph showing a threshold map between pressure of the vapor-phase gas and the valve opening threshold according to the first embodiment;

FIG. 10 is a graph showing a relationship between an opening degree command amount from the control device and the opening degree of the sealing valve according to the first embodiment;

FIG. 11 is a flowchart illustrating a learning operation according to the first embodiment;

FIG. 12 is a flowchart illustrating the learning operation according to the first embodiment;

FIG. 13 is a flowchart illustrating a vapor operation according to the first embodiment;

FIG. 14 is a flowchart illustrating a canister purge operation according to the first embodiment; and

FIG. 15 is a flowchart illustrating a purge operation according to the first embodiment.

### DETAILED DESCRIPTION

Hereinafter, an example of the present disclosure will be described.

According to an example of the present disclosure, in a vehicle having an internal combustion engine, liquid fuel is stored in a fuel tank and is to be used for the internal combustion engine. The gas in the fuel tank exerts pressure such as vapor pressure of the evaporated fuel according to the temperature. When refueling the fuel tank, in order not to release the evaporated fuel to the outside, an evaporative fuel processing device having a canister configured to adsorb the evaporated fuel is used.

Then, before starting fuel supply to the fuel tank, a sealing valve provided in a vapor pipe connecting the fuel tank to the canister is opened to adsorb the fuel vapor in the fuel tank into the adsorbent in the canister. The fuel components adsorbed by the adsorbent of the canister is supplied to the intake pipe of the internal combustion engine and is used for combustion of the internal combustion engine. Further, the evaporated fuel in the fuel tank may be supplied to the intake pipe of the internal combustion engine by bypassing the canister.

The sealing valve used in the evaporative fuel processing device is a normally sealing valve that closes the vapor pipe connecting the fuel tank to the canister. In response to a signal sent from a control device to an actuator of the sealing valve, the sealing valve opens the vapor pipe. The opening/closing operation of the vapor pipe by using the sealing valve can be performed in various manners, such as a simple open/close operation where the opening degree is not adjusted, an operation where the opening degree is adjustable to several levels (such as two levels), and an operation where the opening degree is quantitatively adjusted.

According an example of the present disclosure, an evaporative fuel processing device quantitatively adjusts an opening degree of a sealing valve by using a stepping motor.

In this evaporative fuel processing device, when the fuel tank is depressurized, the flow rate of gas flowing through the purge pipe from the fuel tank to the canister can be adjusted by changing a stroke amount of a sealing valve as the sealing valve. Further, the sealing valve in this evaporative fuel processing device is configured to learn the valve opening start position based on the stroke amount of a valve movable portion with respect to a valve seat in the valve opening direction when the internal pressure of the fuel tank has decreased by a predetermined value or more.

According to an example of the present disclosure, a predetermined value, which is a threshold value for learning the valve opening start position of the sealing valve is set inconsideration of, for example, a variation in the characteristics of the sensor that detects the internal pressure of the fuel tank and a fluctuation in the liquid level caused by vehicle that travels. However, gasoline, which is a fuel, is volatile. Therefore, for example, even when the vehicle is stopped, the internal pressure of the fuel tank is likely to change due to changes in the environment such as the ambient temperature and the remaining amount of fuel. Thus, pressure pulsation occurs, and the variation in the detection value of the sensor may become large.

In such a case, in a case where the valve opening start position is not properly learned, the opening degree of the sealing valve may not be accurately controlled based on the valve opening start position. The threshold for the determination may be set to a value in consideration of the pressure pulsation caused by the environmental factors in order to restrict erroneous learning. However, on the other hand, in a case where the threshold value is large, detection of the valve opening start position takes long in an environment where the pressure pulsation is small. Consequently, the deviation from the actual valve opening start position may become large, and the learning accuracy may decrease.

An evaporative fuel processing device according to an example of the present disclosure is provided in a vehicle 6 that includes an internal combustion engine 61 and a fuel tank 62 and is configured to process evaporated fuel F1 which is fuel evaporated in the fuel tank.

The evaporative fuel processing device 1 includes: a canister 2 including an adsorbent 22 to adsorb evaporative fuel; a sealing valve 3 provided in a vapor pipe 41 connecting the fuel tank to the canister, the sealing valve being configured to be operated by an actuator 35 to quantitatively adjust an opening degree for opening and closing the vapor pipe; a pressure sensor 44 provided in the fuel tank and configured to detect a pressure P of vapor-phase gas in the fuel tank; a purge valve 43 provided in a purge pipe 42 connecting the canister to an intake pipe 611 of the internal combustion engine, the purge valve configured to open and close the purge pipe; a control device 5 configured to selectively execute each of: a sealing operation to cause the sealing valve to close the vapor pipe to seal the fuel tank; a vapor operation 501 to cause the sealing valve to open the vapor pipe to purge the vapor-phase gas in the fuel tank into the canister; a canister purge operation 502 to cause the purge valve to open the purge pipe to purge fuel components in the canister into the intake pipe; a purge operation 503 to cause the sealing valve to open the vapor pipe and at the same time to cause the purge valve to open the purge pipe to purge the vapor-phase gas in the fuel tank into the intake pipe by bypassing the canister; and a learning operation 504 to learn an opening degree of the sealing valve during at least one of the vapor operation or the purge operation.

The control device includes: an opening degree command unit 51 configured to transmit an opening degree command amount K1, which is for determining the opening degree of the sealing valve, to the actuator; a valve opening start learning unit 52 configured to learn the valve opening start amount K0 in the learning operation based on the opening degree command amount when the pressure of the vapor-phase gas starts to decrease when the opening degree command amount is gradually increased from zero; a valve opening threshold set unit 53 configured to set a valve opening threshold TH, which is for determining that the pressure of the vapor-phase gas has started to decrease, based on a before-learning pressure P0, which is the pressure of the vapor-phase gas before a time point when the learning operation is started; and the control device is configured to determine the opening degree command amount of the opening degree command unit based on the valve opening start amount of the valve opening start learning unit when causing the sealing valve to open to perform the vapor operation or the purge operation.

The control device for the evaporated fuel treatment device of the according to this example uses the valve opening threshold, which is for learning the valve opening start amount of the sealing valve, and the valve opening threshold is not a fixed value but a variable value that is set according to the pressure of the vapor-phase gas before the time point when the learning operation is started. The vapor-phase gas in the fuel tank causes a pulsation in which the pressure changes due to an influence of environmental factors such as a high and low ambient temperature and an amount of fuel remaining. It has been found that the magnitude of the pulsation of the pressure increases as the pressure of the vapor-phase gas increases. Therefore, the configuration enables to set the valve opening threshold value appropriately in consideration of pressure pulsation from the tank internal pressure before learning when the closed valve is closed. Further, the configuration increases the valve opening threshold when the pressure of the vapor-phase gas is high, thereby to enable to restrict erroneous determination at the time of the learning. In addition, the configuration decreases the valve opening threshold value when the pressure of the vapor-phase gas is low, thereby to enable the determination at the time of the learning quickly and accurately. Furthermore, the control device performs the vapor operation and purge operation by using the valve opening start amount of the sealing valve that is obtained by the learning, thereby to enable to control the opening degree of the sealing valve with high accuracy.

The example enables to provide the evaporative fuel processing device configured to learn the valve opening start position of the closed valve accurately and to control the opening degree of the closed valve more appropriately and quantitatively.

A preferred embodiment of the above-described evaporative fuel processing device will be described with reference to the drawings.

### First Embodiment

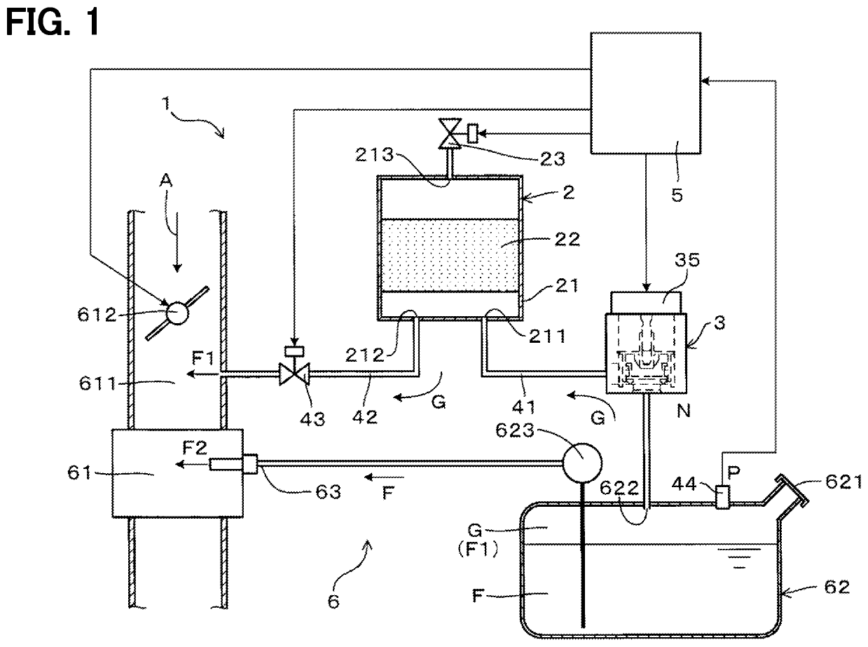

As shown in FIG. 1, an evaporative fuel processing device 1 according to the present embodiment is provided in a vehicle 6. The vehicle 6 includes an internal combustion engine 61 and a fuel tank 62. The evaporative fuel processing device 1 is configured to process evaporated fuel F1 that is fuel F evaporated in the fuel tank 62. The evaporative fuel processing device 1 includes a canister 2, a vapor pipe 41, a sealing valve 3, a pressure sensor 44, a purge pipe 42, a purge valve 43, and a control device 7.

The canister 2 includes an adsorbent 22 that adsorbs the evaporated fuel F1. The vapor pipe 41 connects the fuel tank 62 to the canister 2. The sealing valve 3 is provided in the vapor pipe 41 and includes a stepping motor 35 that acts as an actuator. The stepping motor 35 is configured to quantitatively adjust the opening degree of the vapor pipe 41 in accordance with operation of the stepping motor 35. The pressure sensor 44 is provided in the fuel tank 62 and detects a pressure P, which is pressure of the vapor-phase gas in the fuel tank 62. The purge pipe 42 connects the canister 2 to an intake pipe 611 of the internal combustion engine 61. The purge valve 43 is provided in the vapor pipe 42 and is configured to open and close the vapor pipe 42.

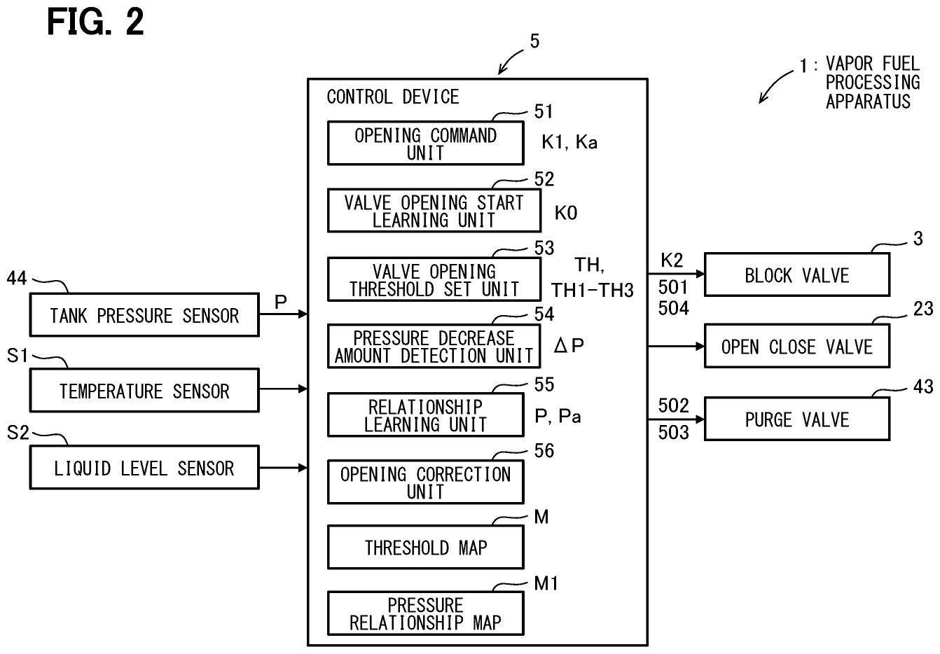

As shown in FIG. 2, the control device 5 is configured to execute each of a closing operation, a vapor operation 501, a canister purge operation 502, a purge operation 503, and a learning operation 504. The sealing operation is an operation in which the vapor pipe 41 is closed by using the sealing valve 3 to seal the fuel tank 62.

The vapor operation 501 is an operation to open the vapor pipe 41 by using the sealing valve 3 and to purge the gas G in the fuel tank 62 to the canister 2.

The canister purge operation 502 is an operation to open the purge pipe 42 by using the purge valve 43 and to purge the fuel component in the canister 2 into the intake pipe 611.

The purge operation 503 is an operation to open the vapor pipe 41 by using the sealing valve 3 and to open the purge pipe 42 by using the purge valve 43 to purge the gas G in the fuel tank 62 to the intake pipe 611 by bypassing the canister 2.

The learning operation 504 is an operation to learn the opening degree of the sealing valve 3 in at least one of the vapor operation 501 and the purge operation 503.

Further, the control device 5 includes an opening degree command unit 51, a valve opening start learning unit 52, and a valve opening threshold set unit 53. The control device 5 determines an opening degree command amount K1 of the opening degree command unit 51 based on a valve opening start amount K0 of the valve opening start learning unit 52, when the sealing valve 3 is opened to perform the vapor operation 501 or the purge operation 503.

The opening degree command unit 51 is a control unit that transmits an opening degree command amount K1 to the stepping motor 35. The opening degree command amount K1 determines the opening degree of the sealing valve 3.

The valve opening start learning unit 52 is a control unit that learns the valve opening start amount K0 based on the opening degree command amount K1 when the pressure P of the vapor-phase gas G starts to decrease in a condition where the opening degree command amount K1 is gradually increased from zero in the learning operation 504.

The threshold set unit is a control unit that sets the valve opening threshold TH, which is for determining that the pressure P of vapor-phase phase gas G has started to decrease, based on a before-learning pressure P0, which is the pressure P of the vapor-phase gas G before the time point when the learning operation 504 is started.

Preferably, the control device 5 may include a pressure decrease amount detection unit 54. The pressure decrease amount detection unit 54 is a control unit that detects a pressure decrease amount ΔP, which is a value obtained by subtracting the pressure P of the vapor-phase gas G, when the opening degree command amount K1 is gradually increased from zero, from the before-learning pressure P0. At this time, the valve opening start learning unit 52 may perform the learning operation 504 when the internal combustion engine 61 is stopped or when the operation is started and may determine that the pressure P of the vapor-phase gas has started to decrease when the pressure decrease amount ΔP detected by the pressure decrease amount detection unit 54 becomes equal to or higher than the valve opening threshold TH.

Further, the control device 5 may include a relationship learning unit 55, an opening degree correction unit 56, a threshold map M, and a pressure relationship map M1 which is a relationship map.

Hereinafter, the evaporative fuel processing device 1 of the present embodiment will be described in detail. (EVAP0RATIVE FUEL processing device 1)

As shown in FIG. 1, in the vehicle 6, the evaporative fuel processing device 1 is used such that the evaporated fuel F1, which is part of the vapor-phase gas G in the fuel tank 62, is not released into atmosphere when fuel F is supplied to the fuel tank 62. The evaporated fuel F1 in the fuel tank 62 is stored in the canister 2 and then discharged to the intake pipe 611 of the internal combustion engine 61 or is discharged to the intake pipe 611 of the internal combustion engine 61 by bypassing the canister 2. Then, the fuel component of the evaporated fuel F1 is used for combustion in the internal combustion engine 61.

The flow rate of combustion air A supplied from the intake pipe 611 to the internal combustion engine 61 is adjusted by operating a throttle valve 612 provided in the intake pipe 611. The internal combustion engine 61 is provided with a fuel injection device 63 that injects fuel F supplied from the fuel tank 62.

(Fuel Tank 62)

As shown in FIG. 1, the fuel tank 62 stores the fuel F used for the combustion of the internal combustion engine 61. The fuel tank 62 includes a fuel supply port 621, a purge port 622, and a fuel pump 623. The fuel supply port 621 is used to receive fuel F supplied to the fuel tank 62 from outside. The purge port 622 is connected to the vapor pipe 41. The fuel pump 623 is used when supplying the fuel F to the fuel injection device 63 of the internal combustion engine 61.

A cap that closes the fuel supply port 621 during a normal state is provided over the fuel supply port 621. The cap is opened when refueling through the fuel supply port 621. In the fuel tank 62, a sensor is provided for sensing pressure of the vapor-phase gas G and stopping refueling by the refueling nozzle. The fuel pump 623 supplies liquid phase fuel from the fuel tank 62 to the fuel injection device 63.

(Canister 2)

As shown in FIG. 1, the canister 2 includes a case 21 and an adsorbent 22 such as activated carbon. The adsorbent is in the case 21 and adsorbs the evaporated fuel (i. e. , fuel vapor) F1. The case 21 of the canister 2 includes an inlet 211, an outlet 212, and a pressure release port 213. The inlet 211 is connected to the vapor pipe 41 and allows gas G to enter. The outlet 212 is connected to the purge pipe 42 and allows fuel components to exit. The pressure release port 213 is openable to the atmosphere. An open/close valve 23 for opening and closing the pressure release port 213 is provided at the pressure release port 213. The pressure release port 213 is configured to open to the atmosphere. When the gas G is purged (exhausted) from the fuel tank 62 to the canister 2, the open/close valve 23 opens the pressure release port 213 to the atmosphere. Then, in the canister 2, the fuel components in the evaporated fuel F1 of the gas G are adsorbed by the adsorbent 22, while the pressure in the canister 2 becomes equal to atmospheric pressure.

The fuel components adsorbed by the adsorbent 22 of the canister 2 pass through the purge pipe 42 and are discharged to the intake pipe 611 of the internal combustion engine 61. At this time, the pressure release port 213 of the canister 2 is opened to the atmosphere, and the purge pipe 42 is opened by the purge valve 43. The fuel components adsorbed by the adsorbent 22 are discharged to the intake pipe 611 of the internal combustion engine 61 by an airflow caused due to the pressure difference between the pressure of the atmosphere entering the canister 2 through the pressure release port 213 and the negative pressure in the intake pipe 611.

(Sealing Valve 3)

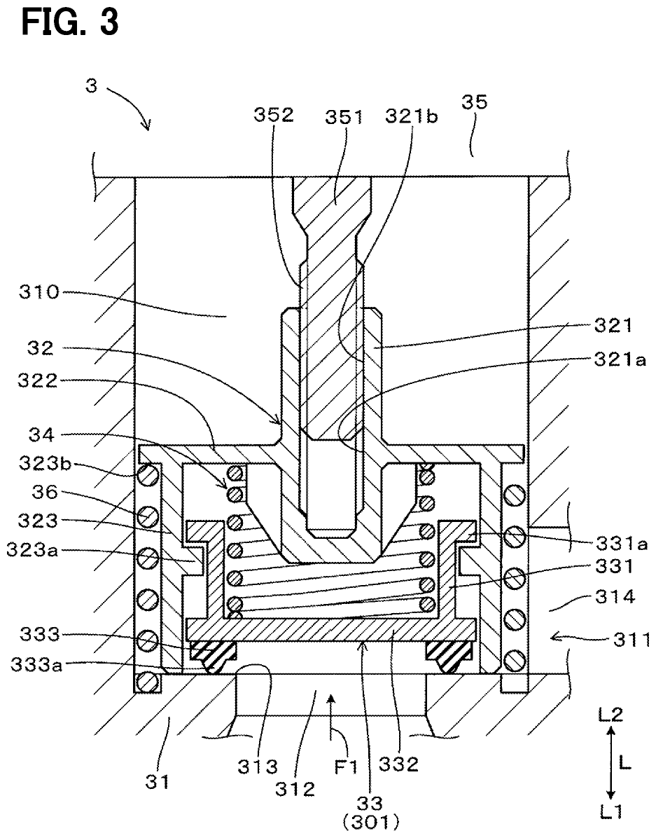

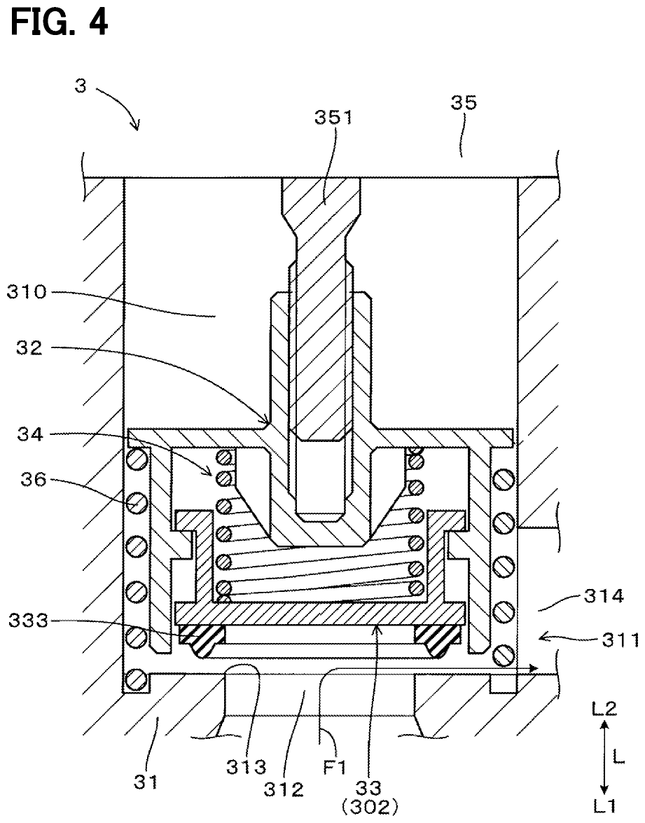

As shown in FIGS. 3 and 4, the sealing valve 3 of the present embodiment includes a housing 31, a valve guide 32, a valve 33, a valve-side spring 34, a stepping motor 35, and a guide-side spring 36. The housing 31 forms a case for the sealing valve 3, and includes a sealing passage 311 connected to the vapor pipe 41. The valve guide 32 is configured to be movable forward and backward with respect to the housing 31 by converting the rotational force of the stepping motor 35 into an actuating force. The valve 33 is slidably engaged with the valve guide 32 and is configured to open and close a sealing passage 311 of the housing 31.

The valve-side spring 34 is sandwiched between the valve guide 32 and the valve 33 and biases the valve 33 in a direction to close the sealing passage 311. The guide-side spring 36 is disposed on the outer periphery of the valve guide 32, and serves to reduce rattling (backlash) generated between an output shaft 351 of the stepping motor 35 and the valve guide 32.

(Housing 31)

As shown in FIGS. 3 and 4, the housing 31 includes an accommodation hole 310 for housing the valve guide 32 and the sealing passage 311 which is in communication with the accommodation hole 310. The accommodation hole 310 is formed in a proximal side L2 along the axial direction L of the housing 31. The sealing passage 311 includes an inflow portion 312 and an outflow portion 314. The inflow portion 312 is connected to the fuel tank 62. The gas G flows in through the inflow portion 312. Further, the gas G flows out through the outflow portion 314 to the canister 2. The inflow portion 312 is formed parallel to the accommodation hole 310 at the distal side L1 of the accommodation hole 310, and the outflow portion 314 is formed perpendicular to the accommodation hole 310.

(Axial Direction L)

The axial direction L is a direction parallel to the direction along which the valve 33 opens and closes the sealing passage 311. In the axial direction L of the sealing valve 3, the side on which the stepping motor 35 is disposed is referred to as the proximal side L2, and the side on which the sealing passage 311 is closed by the valve 33 is referred to as the distal side L1.

(Valve Guide 32)

As shown in FIGS. 3 and 4, the valve guide 32 includes a center shaft portion 321, a guide disc portion 322, a guide tubular portion 323, and a locking portion 323a. The center shaft portion 321 is fixed to the output shaft 351 of the stepping motor 35. The guide disk portion 322 is formed around the center shaft portion 321. The guide tubular portion 323 is formed in a cylindrical shape protruding from the peripheral portions of the guide disk portion 322. The locking portion 323a is formed on the inner peripheral surface of the guide tubular portion 323 to lock the valve 33. A male threading 352 is formed on the outer surface of the output shaft 351 of the stepping motor 35. A hollow hole 321a is formed at the center of the center shaft portion 321 of the valve guide 32, and a female threading 321b is formed on the inner surface of the hollow hole 321a. The female threading 321b is screwed together with the male threading 352 of the output shaft 351 of the stepping motor 35. The locking portion 323a is formed as a protruding portion that protrudes inward from the inner peripheral surface of the guide tubular portion 323. The main body of the stepping motor 35 is fixed to the housing 31.

(Valve 33)

As shown in FIGS. 3 and 4, the valve 33 includes a valve tubular portion 331, a valve closing plate portion 332, and a sealing member 333. The valve tubular portion 331 is disposed inside the guide tubular portion 323 of the valve guide 32. Further, the valve tubular portion 331 includes a locking protrusion 331a configured to lock with the locking portion 323a of the valve guide 32. The valve closing plate portion 332 closes the end portion of the valve tubular portion 331. The sealing member 333 is a ring-shaped member disposed on the valve closing plate portion 332. The sealing member 33 is configured to close an opening portion 313 of the sealing passage 311. The valve tubular portion 331 is formed in a cylindrical shape and guides the outer periphery of the valve-side spring 34. The locking protrusion 331a is formed so as to protrude radially outward from an end portion of the valve tubular portion 331 on the proximal side L2 of the axial direction L. The valve closing plate portion 332 and the locking protrusion 331a are guided in the axial direction L by the inner circumference of the guide tubular portion 323 of the valve guide 32.

The sealing member 333 is arranged in the housing 31 at the periphery of the opening portion 313 of the inflow portion 312 of the sealing passage 311. A sealing portion 333a is formed in the housing 31 on the distal side L1 of the sealing member 333 in the axial direction. The sealing portion 333a is configured to elastically deform when coming into contact with the peripheral portion of the opening portion 313 of the inflow portion 312 of the sealing passage 311. The position of the distal side L1 of the entirety of the sealing portion 333a in the axial direction L is within an imaginary plane parallel to the surface of the valve closing plate portion 332 on the proximal side L2 in the axial direction L.

The valve 33 is biased toward the distal side L1 in the axial direction L by the valve-side spring 34, and the locking protrusion 331a of the valve tubular portion 331 of the valve 33 engages with the locking portion 323a of the guide tubular portion 323 of the valve guide 32. Due to this, the valve 33 is retained within the valve guide 32. As shown in FIGS. 3 and 4, the valve 33 is movable between a closed position 301 and an open position 302. Specifically, the valve 33 is normally in the closed position 301 due to being biased by the valve-side spring 34 to close the sealing passage 311. Further, the valve 33 is configured to be moved toward the open position 302 in accordance with a movement amount of the valve guide 32 toward the proximal side L2 in the axial direction L. The open position 302 determines the opening degree of the sealing passage 311. The closed position 301 is also referred to as an initial position (normal position) of the valve 33. In other words, the default state of the valve 33 is to close the sealing passage 311 with the sealing member 333.

As shown in FIG. 3, the opening portion 313 of the inflow portion 312 of the sealing passage 311 is normally closed by the sealing portion 333a of the sealing member 333 of the valve 33. In this state, the valve-side spring 34 is in a compressed state and applies a spring force on the valve closing plate portion 332 toward the distal side L1 of the axial direction L. At the same time, the gas G in the inflow portion 312 exerts a fuel pressure on the valve closing plate portion 332 toward the proximal side L2 of the axial direction L. In the state shown in FIG. 3, the spring force is greater than the fuel pressure. As a result, the valve 33 is maintained at the closed position 301, and the sealing passage 311 is maintained in a closed state.

On the other hand, as shown in FIG. 4, when the valve guide 32 is moved by the stepping motor 35 toward the proximal side L2 in the axial direction L in order to open the opening portion 313 of the inflow portion 312 of the sealing passage 311, the valve 33 and the valve-side spring 34 are also moved toward the proximal side L2 in the axial direction L. As a result, the sealing portion 333a of the sealing member 333 of the valve 33 separates from the peripheral edge of the opening portion 313 of the inflow portion 312 of the sealing passage 311 in the housing 31, and the valve 33 moves to the open position 302, and the sealing passage 311 is opened. In this manner, the amount by which the valve guide 32, the valve 33, and the valve-side spring 34 move toward the proximal side L2 in the axial direction L is determined according to the number of drive pulses applied to the stepping motor 35. Thus, the opening amount of the sealing passage 311 is quantitatively determined.

(Valve-Side Spring 34, Guide-Side Spring 36)

As shown in FIGS. 3 and 4, the valve-side spring 34 and the guide-side spring 36 are compression coil springs (torsion coil springs) in which a round wire as a strand is spirally twisted. The valve-side spring 34 applies a predetermined biasing force to the valve 33 to close the sealing passage 311, and is configured to retain the valve 33 at the closed position 301 through this biasing force. The guide-side spring 36 is arranged on the outer circumference of the guide tubular portion 323 of the valve guide 32. The guide-side spring 36 is interposed between a step portion 323b, which is formed on the guide tubular portion 323, and the peripheral edge of the opening portion 313 of the inflow portion 312 of the sealing passage 311 in the housing 31.

The valve guide 32 is biased by the guide-side spring 36 to the proximal side L2 in the axial direction L, and therefore, a gap between the male threading 352 of the output shaft 351 of the stepping motor 35 and the female threading 321b of the central hole of the center shaft portion 321 of the valve guide 32 is held on one side in the axial direction L. Thus, when the output shaft 351 of the stepping motor 35 rotates, backlash between the output shaft 351 and the valve guide 32 in the axial direction L is reduced.

(Purge Valve 43)

As shown in FIG. 1, the purge valve 43 is configured to open the purge pipe 42 when purging (discharging) the fuel component adsorbed by the adsorbent 22 of the canister 2 to the intake pipe 611 of the internal combustion engine 61 and when purging (discharging) the gas G in the fuel tank 62 to the intake pipe 611 of the internal combustion engine 61. The purge valve 43 of this embodiment has a function of opening and closing the purge pipe 42 in an on or off manner.

The purge valve 43 may be repeatedly opened and closed using a pulse-shaped energization command signal, and by controlling the on/off ratio (duty ratio) of the pulse width, the opening degree of the purge pipe 42 may be quantitatively adjusted. In this case, in the canister purge operation, the flow rate of the purge gas containing fuel components flowing through the purge valve 43 can be appropriately adjusted. Alternatively, the purge valve 43 may be a control valve that can quantitatively adjust the opening degree at which the purge pipe 42 is opened.

(Pressure Sensor 44)

As shown in FIG. 1, the pressure sensor 44 is a pressure gauge that detects the pressure P of the gas G in the fuel tank 62. Most of the pressure P of the gas G in the fuel tank 62 is due to the vapor pressure of the evaporated fuel F1.

(Control Device 5)

As shown in FIGS. 1 and 2, the control device 5 of the evaporated fuel processing device 1 is disposed in a control device of the vehicle. The sealing valve 3, the purge valve 43, and the open/close valve 23 are connected to the control device 5 of the vehicle 6 as output devices, and are configured to open and close in response to a command from the control device 5. When a predetermined number of drive pulses are supplied from the control device 5 to the stepping motor 35 in the sealing valve 3, the valve 33 opens the opening portion 313 of the sealing passage 311. The pressure sensor 44, is connected to the control device 5 of the vehicle 6 as input devices, and are configured to transmit information on the pressure P to the control device 5.

Further, the control device 5 is configured to transmit various environmental information related to an internal environment of the fuel tank 62 or a surrounding environment of the fuel tank 62 based on various sensors and the like provided inside and outside the fuel tank 62. The environmental information includes, for example, temperature information from the temperature sensor S1 that detects the temperature of the fuel tank 62 or the temperature of surroundings of the fuel tank 62, fuel remaining amount information from the liquid level sensor S2 that detects the remaining amount of fuel F in the fuel tank 62, volatility information of fuel F determined from the type and properties of fuel F in the fuel tank 62, travel history information of vehicle 6, and the like. The temperature information and the remaining fuel amount information may be information estimated based on the operating state of the internal combustion engine 61 and the like.

Note that the control device 5 of the evaporated fuel processing device 1 may be provided separately from the control device of the vehicle 6, and may be connected to a separate control device disposed within the control device of the vehicle 6 so that data can be transmitted and received between the evaporated fuel processing device 1 and the vehicle 6.

In a normal state, in the internal combustion engine (engine) 61 of the vehicle 6, the amount (mass) of the combustion air A supplied to the intake pipe 611 is adjusted by the opening degree of the throttle valve 612, and the supply amount (mass) of the fuel F to the internal combustion engine 61 is adjusted by the injection amount of the fuel injection device 63. Then, the control device 5 controls an air-fuel ratio (A/F) as the supply amount of combustion air to the fuel supply amount to be a target air-fuel ratio.

When the evaporated fuel F1 is not purged from the fuel tank 62 or the canister 2 to the intake pipe 611, the fuel supply to the internal combustion engine 61 is only the supply of the injected fuel F2 by using the fuel injection device 63, and a normal feedback control is performed on the internal combustion engine 61. When the evaporated fuel F1 is purged from the canister 2 or the fuel tank 62 to the intake pipe 611 of the internal combustion engine 61 by performing the purge operation 503 or the canister purge operation 502, the control device 5 reduces the amount of fuel supplied from the fuel injection device 63 to the internal combustion engine 61 so as to regulate the air-fuel ratio in the internal combustion engine 61.

(Operation 501, 502, 503, 504 by Control Device 5)

The sealing operation by the control device 5 refers to an operation in which the valve 33 of the sealing valve 3 closes the opening portion 313 of the sealing passage 311 and maintains the fuel tank 62 in a sealed state. During the sealing operation, the rotation position of the output shaft 351 of the stepping motor 35 is held to maintain a state in which the valve 33 is at the closed position (initial position) 301. During normal operation of the evaporative fuel processing device 1, the control device 5 executes the sealing operation. In other words, the sealing operation is performed by default.

The vapor operation 501 by the control device 5 is performed when, prior to refueling the fuel tank 62, the vapor-phase fuel G in the fuel tank 62 is purged to the canister 2. The pressure P of the gas G in the fuel tank 62 is decreased by performing the vapor operation 501. When the fuel filler port 621 of the fuel tank 62 is opened, the evaporated fuel F1 in the gas G of the fuel tank 62 is restricted from being released into the atmosphere.

The canister purge operation 502 by the control device 5 is performed when the fuel component adsorbed by the adsorbent 22 of the canister 2 is to be used in the internal combustion engine 61 to burn a mixture of fuel and combustion air.

The purge operation 503 by the control device 5 is performed when, after the fuel tank 62 is refueled and the internal combustion engine 61 initiates a combustion operation, the gas G in the fuel tank 62 is supplied to the intake pipe 611 of the internal combustion engine 61. In the purge operation 503, the evaporated fuel F1 in the gas G passes through a part of the canister 2 without being adsorbed by the adsorbent 22 of the canister 2. By performing the purge operation 503, the pressure P of the gas G in the fuel tank 62 can be reduced during the combustion operation of the internal combustion engine 61.

The learning operation 504 by the control device 5 is performed while the sealing operation by the control device 5 is being performed, and includes gradually increasing the opening degree command amount K1, which is sent from the opening degree command unit 51 to the stepping motor 35, from zero. Further, the learning operation 504 is performed during a process in which the pressure P of the gas G in the fuel tank 62 changes while the sealing operation is being performed.

In the closed state of the fuel tank 62, that is, in the state in which the valve 33 of the sealing valve 3 closes the opening portion 313 of the sealing passage 311, the learning operation 504 is performed to increase the command amount to the stepping motor 35, thereby to cause the valve 33 to be lifted from the opening portion 313 at a certain time point and to open the sealing passage 311. The relationship with the valve opening start amount K0 is learned based on the change in the pressure P of the vapor-phase gas G in the fuel tank 62 and the opening degree command amount K1 at this time. Further, by performing the learning operation 504, a pressure relationship map M1 between the valve opening start amount K0 and the pressure P can be obtained for multiple cases where the pressure P before the start of the learning operation 504 is different.

(Specific Configuration of Control Device 5)

As shown in FIG. 2, the control device 5 includes an opening degree command unit 51, a valve opening start learning unit 52, a valve opening threshold set unit 53, a pressure decrease amount detection unit 54, a relationship learning unit 55, and an opening degree correction unit 56. The control device 5 has a function to learn the valve opening start amount K0 as a dead zone caused in the sealing valve 3 and a function to correct the dead zone. By paying attention to the fact that the sealing valve 3 opens only when the command amount to the stepping motor 35 for driving the sealing valve 3 reaches a predetermined amount, the function to learn the dead zone is a function to learn the predetermined amount. The function to correct the dead zone is a function to correct the command amount by the predetermined amount as learned.

In the control device 5, the opening degree command unit 51 is configured to transmit an opening degree command amount K1 for determining the opening degree of the sealing valve 3 to the stepping motor 35. The valve opening start learning unit 52 is a control unit that has a function to learn the dead zone and learns the valve opening start amount K0 based on the opening degree command amount K1 when the pressure P of the vapor-phase gas G starts to decrease.

In the present embodiment, the time point when the pressure P of the vapor-phase gas G starts to decrease can be the time point when the sealing valve 3 changes from the closed state to the open state, that is, when the sealing valve 3 reaches the valve opening start position.

The valve opening threshold set unit 53 sets the valve opening threshold TH that is for determining that the pressure P of the vapor-phase gas G has started to decrease. The valve opening threshold TH is configured to perform the setting based on the before-learning pressure P0, which is the pressure P of the vapor-phase gas G before the start of the learning operation 504, and by collating with the threshold map M stored in advance.

The pressure decrease amount detection unit 54 is configured to detect a pressure decrease amount ΔP, which is a value obtained by subtracting the pressure P of the vapor-phase gas G, when the opening degree command amount K1 is gradually increased from zero, from the before-learning pressure P0. In addition, the valve opening start learning unit 52 determines that the pressure P of the vapor-phase gas has started to decrease when the pressure decrease amount ΔP detected by the pressure decrease amount detection unit 54 becomes equal to or higher than the valve opening threshold TH.

The relationship learning unit 55 learns in the learning operation 504 the relationship between multiple different values of the different before-learning pressure P0 and multiple different values of the valve opening start amount K0, when the valve opening start learning unit 52 learns the multiple different values of the valve opening start amount K0 corresponding to the multiple different values of the before-learning pressure P0. Then, the relationship learning unit 54 is configured to create a pressure relationship map M1 showing the relationship between the valve opening start amount K0 and the pressure P of the vapor-phase gas G.

The opening degree correction unit 56 has a function to correct the dead zone. The opening degree correction unit 56 collates the operating pressure Pa to the pressure relationship map M1. The operating pressure Pa is the pressure P of the vapor-phase gas G detected by using the pressure sensor 44 when the sealing valve 3 is opened to perform the vapor operation 501 or the purge operation 503. Then, the opening degree correction unit 56 reads an in-operation valve opening start amount Ka, which is the valve opening start amount K0 at this time, and corrects the opening degree command amount K1 of the opening degree command unit 51 by the in-operation valve opening start amount Ka.

(Opening Degree Command Unit 51)

As shown in FIG. 2, the opening degree command unit 51 of the control device 5 transmits the opening degree command amount K1 to the stepping motor 35 of the sealing valve 3 during the vapor operation 501, the purge operation 503, and the learning operation 504. The opening degree command amount K1 is a predetermined number of drive pulses for driving the stepping motor 35. The opening degree command amount K1 from the opening degree command unit 51 is determined by the number of drive pulses for driving the stepping motor 35. The output shaft 351 of the stepping motor 35 rotates by a predetermined angle in response to each drive pulse transmitted to the stepping motor 35. Accordingly, the valve guide 32, the valve 33, and the valve-side spring 34 move by a predetermined amount in the axial direction L per drive pulse as well.

As shown in FIGS. 3 and 4, the opening degree of the sealing valve 3 is determined according to the number of pulses transmitted to the stepping motor 35. However, a dead zone exists in the sealing valve 3. The dead zone means that the valve 33 is actually closed even when the stepping motor 35 is energized in a step-like manner while the valve 33 of the sealing valve 3 is in the closed position 301. The dead zone is defined as the number of pulses that do not move the valve 33 from the position 301, in other words, an integrated value of the number of the pulse transmitted during which the sealing member 333 of the valve 33 does not separate from the sealing passage 311 and the pressure P of the vapor-phase gas G does not begin to decrease. In addition, the number of pulses equal to the dead zone is represented as a valve opening start amount K0 of the sealing valve 3.

As shown in FIG. 5, The valve opening start amount K0 compensates for the dead zone of the sealing valve 3. When the valve opening start amount K0 is added to the opening degree command amount K1 by the opening degree command unit 51, the opening degree command amount K1 can be used to proportionally change the opening degree of the sealing valve 3 from zero. During the vapor operation 501 and the purge operation 503, the opening degree command unit 51 determines the opening degree command amount K1 such that the vapor-phase gas G flows through the sealing valve 3 at the target flow rate.

At this time, the valve opening start amount K0 also changes depending on the pressure P of the vapor-phase gas G, and the relationship between the opening degree command amount K1 and the opening degree of the closed valve 3 changes. Therefore, the valve opening start amount K0 can be regarded as an opening correction amount for correcting the opening degree command amount K1 with the opening degree command unit 51. In this case, the valve opening start amount K0 changes as the opening correction amount changes according to the pressure P of the vapor-phase gas G.

(Pressure Relationship Map M1)

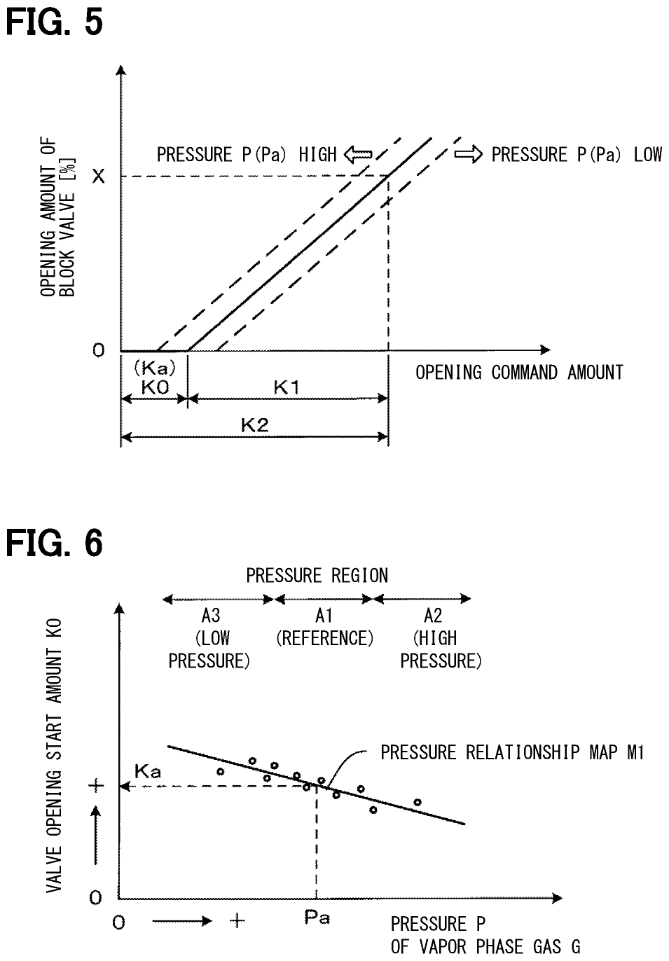

As shown in FIG. 6, in the pressure relationship map M1 between the valve opening start amount K0 and the pressure P of the vapor-phase gas G, the valve opening start amount K0 becomes smaller as the pressure P of the vapor-phase gas G detected by using the pressure sensor 44 becomes higher. In other words, the higher the pressure P of the vapor-phase gas G as detected, the larger the dead zone of the sealing valve 3, and the sealing valve 3 becomes more hardly opens. The pressure relationship map M1 is used to correct the opening degree command amount K1 by using the valve opening start amount K0 after the use of the vehicle 6 and the evaporated fuel processing device 1 is started. An initial map may also be created by repeatedly performing the learning operation 504 when or prior to the start of the use to learn the relationship between the valve opening start amount K0 and the pressure P of the vapor-phase gas G. After the start of the use, the valve opening start amount K0 may be learned, thereby to update the pressure relationship map M1 by performing the learning operation 504 in a timely manner.

(Valve Opening Start Learning Unit 52)

As shown in FIGS. 3 and 4, during the learning operation 504, when the valve 33 is in the closed position (initial position) 301, the valve opening start learning unit 52 of the control device 5 monitors two values: the opening degree command amount K1 transmitted from the opening degree command unit 51 to the stepping motor 35; and the pressure P of the vapor-gas pressure G received from the pressure sensor 44. Then, the valve opening start learning unit 52 learns the valve opening start amount K0 from the change in the opening degree command amount K1 and the pressure P of the vapor-phase gas G. Specifically, the valve opening start learning unit 52 gradually increases the opening degree command amount K1 from zero and determines that the pressure P of the vapor-phase gas G has started to decrease when the amount of decrease in the pressure P of the vapor-phase gas G exceeds a predetermined value. Then, the valve opening start learning unit 52 is configured to set the opening degree command amount K1 when the pressure P of the vapor-phase gas G starts to decrease as the valve opening start amount K0.

For example, in the vapor operation 501, when the fuel tank 62 is purged to the canister 2, in a case where the flow rate of the vapor-phase gas G is too small, the purge of the vapor-phase gas G takes long time, and in a case where the flow rate of the gas phase gas G is too large, a large amount of evaporated fuel F1 in the vapor-phase gas G is adsorbed in the adsorbent 22. Therefore, it is necessary to accurately learn the valve opening start amount K0 corresponding to the dead zone of the closed valve 3 and to set the opening degree of the closed valve 3 appropriately. The learning operation 504 may be performed during the vapor operation 501 by using the closed valve 3 or the purge operation 503. Increase in the opportunity of the learning enables to learn the valve opening start amount K0 for multiple different values of the pressures P of the vapor-phase gas G, thereby to enable to reflect the valve opening start amount K0 on the pressure relationship map Ml.

Preferably, the valve opening start learning unit 52 may perform the learning operation 504 when the internal combustion engine 61 is stopped or started. When the internal combustion engine 61 is stopped, for example, the vapor operation 501 is performed when the vehicle is stopped and refueled. Further, when the ignition switch is turned on at the start of operation to start the operation, the vapor operation 501 may be performed for the learning operation 504 to learn the valve opening start amount K0. In these cases, the vehicle 6 is stopped, and therefore, the influence of the pressure fluctuation due to the traveling of the vehicle can be suppressed. The learning operation 504 may also be performed when the sealing valve 3 is to be opened to perform the purge operation 503 during traveling, thereby to enable to increase the opportunity of the learning.

(Valve Opening Threshold Set Unit 53)

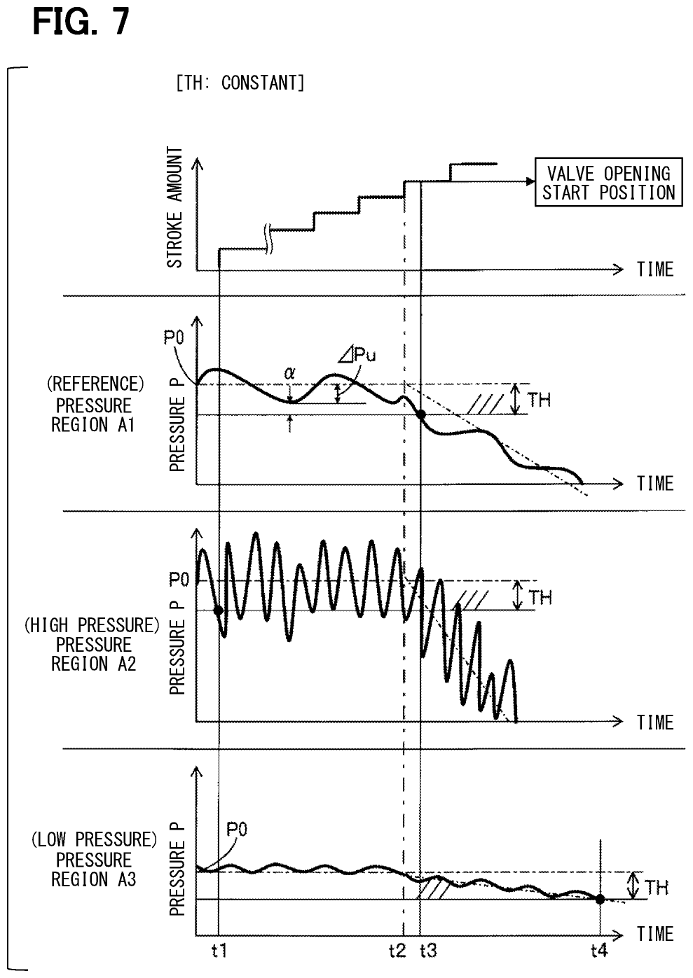

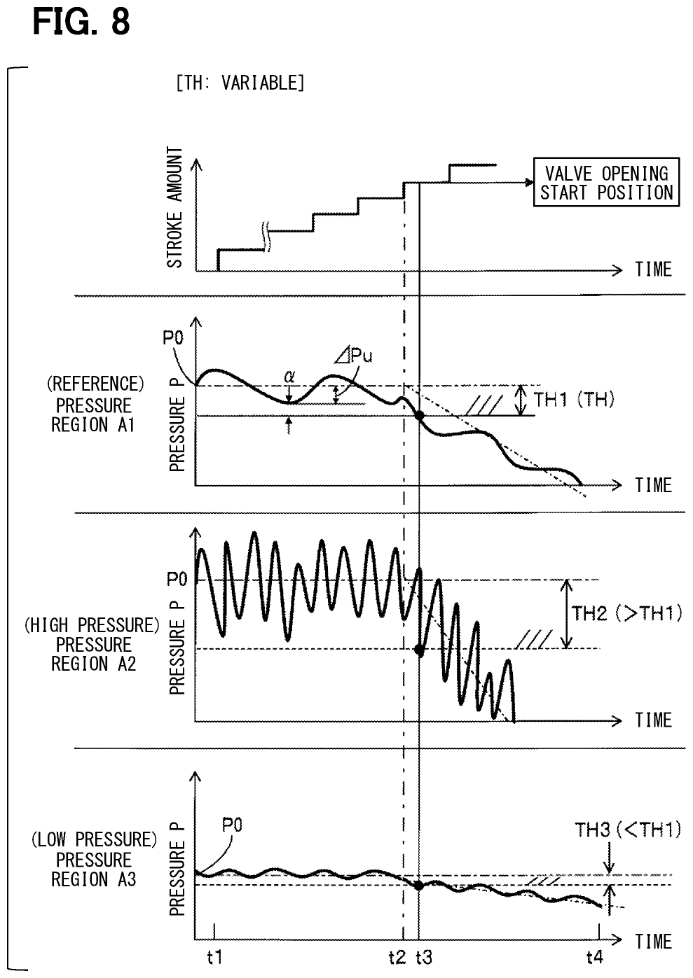

As shown in FIGS. 7 and 8, the valve opening threshold set unit 53 sets, as a variable value, the valve opening threshold TH that is a predetermined value for determining that the pressure P of the vapor-phase gas G has started to decrease according to the before-learning pressure P0 before the time point when the learning operation 504 is started. The before-learning pressure P0 is the pressure P of the vapor-phase gas G when the fuel tank 62 is in a sealed state before the opening degree command amount K1 increases from zero. The before-learning pressure P0 is a reference value for calculating the decrease amount of pressure P. The before-learning pressure P0 may be a value obtained by averaging multiple values of the pressure P of vapor-phase phase gases G received from the pressure sensor 44 in a predetermined section immediately before the learning operation 504 is started and may enable to influence of a pulsation component.

When the learning operation 504 is performed, it is desirable that the pressure P of the vapor-phase gas G received from the pressure sensor 44 is in a stable state. However, it is noted that, gasoline used as fuel contains highly volatile components. Therefore, as shown in FIG. 7, the pressure P of the vapor-phase gas G tends to pulsate due to the influence of the remaining amount of gasoline and the surrounding environment. In addition, it is found that this pulsation amount tends to increase as the before-learning pressure P0 increases. Therefore, when a constant valve opening threshold TH is used, a concern arises that pressure decrease due to the pulsation may be erroneously determined as the start of opening of the closed valve 3 or that the pressure decrease may take excessively long.

Therefore, as shown in FIG. 8, the valve opening threshold TH is set so that as the before-learning pressure P0 becomes higher, the valve opening threshold TH becomes larger. Herein, as follows, a pressure region A in which the before-learning pressure P0 may take is divided into three pressure regions A1, A2, and A3 (A2>A1>A3), and three levels of valve opening thresholds TH1, TH2, and TH3 (TH2>TH1>TH3) are set correspondingly.

Pressure region A1 (reference): TH1

Pressure region A2 (high-pressure): TH2

Pressure region A3 (low-pressure): TH3

When the before-learning pressure P0 is in the reference pressure region A1, a reference valve opening threshold TH1 is selected. When the before-learning pressure P0 is in the higher pressure region A2, a valve opening threshold TH2 larger than the valve opening threshold TH1 is selected. When the before-learning pressure P0 is in the lower pressure region A3, a valve opening threshold TH3 smaller than the valve opening threshold TH1 is selected. The three pressure regions A is set in consideration of the magnitude of pressure pulsation. With respect to the reference pressure region A1 (for example, ±10 kPa), the pressure pulsation becomes larger (for example, ±20 kPa) in the pressure region A2, and the pressure pulsation becomes smaller (for example, ±5 kPa) in the pressure region A3.

(Pressure Decrease Amount Detection Unit 54)

The pressure decrease amount detection unit 54 detects the pressure decrease amount ΔP from the before-learning pressure P0 when the opening degree command amount K1 is gradually increased from zero by the learning operation 504. The pressure decrease amount ΔP is calculated as a value obtained by subtracting the pressure P of the vapor-phase gas, G, when the opening degree command amount K1 is gradually increased from zero, from the before-learning pressure P0 (that is, ΔP=P0 −P). The valve opening start learning unit 52 compares the valve opening thresholds TH1 to TH3, which have been set according to the before-learning pressure P0, with the pressure decrease amount ΔP detected at appropriate time while increasing the opening degree command amount K1. The valve opening start learning unit 52 determines that the valve opening is started when the pressure decrease amount ΔP becomes the valve opening threshold value TH1 to TH3 or more (that is, ΔP TH1 to TH3).

As shown in FIG. 7, in each of the pressure regions A1, A2, and A3, the stroke amount of the valve 33 corresponding to the opening degree command amount K1 of the sealing valve 3 is gradually increased from the time point t1 to the time point t2.

In a case where the valve 33 reaches the stroke amount at which the valve 33 can be separated from the closed position 301 after the time point t2, the values of the valve opening start determination position according to the valve opening threshold TH are compared to each other.

As described above, the valve opening start amount K0 of the sealing valve 3 changes depending on the magnitude of the pressure P (before-learning pressure P0) of the vapor-phase gas G. Therefore, the timing at which the pressure decrease starts differs in different pressure regions A. However, for the sake of explanation, the deviation of the valve opening start position due to the difference in the pressure regions A1, A2, and A3 is ignored here, and the comparison is made with the timings of pressure decrease that are aligned to each other.

For example, the valve opening threshold TH, which is a constant vale, is set to a magnitude, such that an erroneous operation does not occur for the pulsation amount in the reference pressure region A1. In this case, when the stroke amount of the valve 33 corresponding to the opening degree command amount K1 is gradually increased, the pressure P of the vapor-phase gas G begins to decrease at time point t2, and the pressure decrease amount ΔP reaches the valve opening threshold TH at time point t3 immediately after time point t2. Thus, the valve open/close operation is made promptly. To the contrary, in the higher pressure region A2, even though the closed state of the sealing valve 3 is maintained until the time point t2, the determination of the valve opening start is erroneously made at the time point t1 due to the pressure decrease caused by the pulsation. Further, in the lower pressure region A3, even when the pressure decrease starts at the original valve opening start position, the amount of pressure decrease is small, and therefore, the determination is not made until the time point t4 which largely exceeds the time point 3.

To the contrary, as shown in FIG. 8, in a case where the valve opening thresholds TH1 to TH3 are set according to the before-learning pressure P0 in in the pressure regions A1, A2, and A3, respectively, the determination is made in the vicinity of the original valve opening start position. For example, in the higher pressure region A2, a larger valve opening threshold TH2 is set according to the amount of the pulsation. Therefore, when the stroke amount of the valve 33 corresponding to the opening degree command amount K1 is gradually increased, the pressure decrease amount ΔP does not reach the valve opening threshold TH2 until the pressure decrease starts to decrease beyond the time point t2. Further, in the lower pressure region A3, the valve opening threshold value TH3 is set to be smaller according to the amount of the pulsation. Therefore, when the pressure starts to decrease at the time point t2 or later, the pressure decrease amount ΔP quickly reaches the valve opening threshold value TH3.

In this way, the configuration enables to set the multiple pressure regions A1 to A3 corresponding to the before-learning pressure P0 and set the multiple valve opening thresholds TH1 to TH3 corresponding to the multiple pressure regions A1 to A3, respectively. The configuration further enables to learn the relationships in advance and store the relationship as the threshold map M. The valve opening start learning unit 52 reads the valve opening thresholds TH1 to TH3 corresponding to the before-learning pressure with reference to the threshold map M and performs the learning operation 504, thereby to enable to learn the valve opening start amount K0 accurately while restricting an erroneous determination.

Specifically, the configuration sets the before-learning pressure P0 (for example, the median value of each of the pressure regions) as a reference for each of the pressure regions A1 to A3 in advance. The configuration further sets, from the maximum value Pmax and the minimum value Pmin in the pressure pulsation waveform in those cases, the the valve opening threshold TH to be larger, as the pulsation amount, which is the difference between the maximum value Pmax and the minimum value Pmin, becomes larger. For example, a value that is half of the pulsation amount is set as a pulsation component ΔPu (that is, ΔPu=(Pmax-Pmin)/2), and the configuration sets the valve opening threshold TH to a value larger than this pulsation component ΔPu. Preferably, the valve opening threshold TH may be set by adding a predetermined margin a to the pulsating component ΔPu as described in the following equation.

TH=ΔPu+α=(Pmax-Pmin)/2)+α

The pressure regions are not limited to the three regions A1 to A3. When creating the threshold map M, an appropriate number of pressure regions A may be set, and the valve opening threshold TH may be set for each of the pressure regions A in consideration of pressure pulsation. The pressure at the boundary between the regions is not particularly limited and may be appropriately set. Further, as shown in FIG. 8, the configuration may learn the relationship between the pressure P of the vapor-phase gas G, which is the before-learning pressure P0, and the valve opening threshold TH, and may store the threshold map M as a relational equation based on the result of the learning In this case, the valve opening threshold TH is calculated based on the before-learning pressure P0 and the relational equation.

Further, the valve opening threshold set unit 53 may set the valve opening threshold TH, which is set by using the before-learning pressure P0, as a corrected threshold that is corrected based on at least one of environmental information inside and outside the fuel tank 62 that exerts influence on the pressure pulsation. As the environmental information, at least one of the temperature of the fuel tank 62, the remaining amount of fuel in the fuel tank 62, and the fuel property in the fuel tank 62 may be used. The environmental information is not limited to those. The valve opening threshold TH may also be corrected based on the condition of the road surface of the traveling path of the vehicle 6 and the operating condition of the internal combustion engine 61 in a configuration in which, for example, the learning operation 504 is performed immediately after the vehicle 6 travels or during the vehicle 6 is traveling.

As shown in FIG. 2, these environmental information is based on the information from various sensors input to the control device 5 and the information from the control device of the vehicle 6. Among these environmental information, the temperature of the fuel tank 62 can be detected or estimated by using the temperature sensor S1 provided around the fuel tank 62, and the remaining amount of fuel in the fuel tank 62 can be detected by using the liquid level sensor S2 installed in the fuel tank 62. The property of fuel in the fuel tank 62 is a property that exerts influence on the pressure P of the vapor-phase gas G, such as the volatility of the fuel F, and can be obtained, as fuel information corresponding to the internal combustion engine 61, from the control device of the vehicle 6.

These changes in the environmental information exerts influence on the tendency of change in the pressure P of the vapor-phase gas G in the fuel tank 62 and exerts influence on the magnitude of the pressure pulsation. The magnitude of the pressure pulsation increases, as the temperature of the fuel tank 62 increases, and increases as the amount of fuel remaining in the fuel tank 62 increases. Further, as the volatility of the fuel F in the fuel tank 62 becomes higher, the magnitude of the pressure pulsation becomes larger.

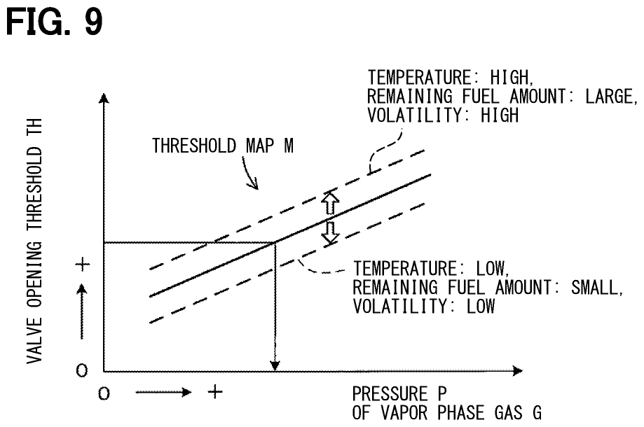

Therefore, as shown in FIG. 9, the configuration may set the valve opening threshold TH corresponding to the pressure P of the vapor-phase gas G, which is the before-learning pressure P0, ant may detect the environmental information. The configuration may use the corrected threshold value obtained by correcting the valve opening threshold value TH according to the magnitude of the environmental information for the learning in the valve opening start learning unit 52. In that case, the configuration sets a reference region, that is, sets a region that need not be corrected with respect to a reference characteristic line that shows the relationship between the pressure P of the vapor-phase gas G and the valve opening threshold TH, for each item of the environmental information. The configuration further corrects the reference valve opening threshold TH when the pressure pulsation is in a region where the pressure pulsation is larger or smaller than the reference region. Specifically, the configuration performs correction to further increase or decrease the reference valve opening threshold TH according to the number and the magnitude of the environmental information that exerts influence on the pressure pulsation, thereby to enable to determine the valve opening start caused by the pressure pulsation more quickly and accurately.

(Relationship Learning Unit 55)

As shown in FIG. 6, the relationship learning unit 55 of the control device 5 is provided so that, after the vehicle 6 and the evaporative fuel processing device 1 are started, the opening degree command unit 51 can correct the opening degree command amount K1 based on the pressure P of the gas G. The relationship learning unit 55 learns the relationship between the valve opening start amount K0 and the pressure P of the vapor-gas pressure G for different values of the pressure P of the vapor-gas pressure G that is the before-learning pressure P0 in a state where the valve 33 is in the closed position 301 by using the valve opening start amount K0 that is learned by the valve opening start learning unit 52. Then, relationship learning unit 54 is configured to create or update the pressure relationship map M1 between the valve opening start amount K0 and the pressure P of the vapor-gas pressure G.

As shown in FIGS. 3 and 4, the pressure P of the vapor-gas pressure G acting on the inflow portion 312 of the sealing passage 311 is higher than the pressure in the canister 2 acting on the outflow portion 314 of the sealing passage 311. A net pressure acts on the valve 33 that biases the valve 33 toward the proximal side L2 in the axial direction L. Then, as the pressure P increases, the net pressure, which biases the valve 33 toward the proximal side L2 of the axial direction L, also increases. For this reason, the valve opening start amount K0 of the open/close valve 23 detected by the valve opening start learning unit 52 is smaller as the pressure P increases.

(Opening Degree Correction Unit 56)

As shown in FIG. 5, the opening degree correction unit 56 of the control device 5 corrects the opening degree command amount K1 from the opening degree command unit 51 by taking the valve opening start amount K0 into consideration. As a result, even in a configuration where the opening degree of the sealing valve 3 is not directly measured, the opening degree correction unit 56 enables to correct an error factor caused by the dead zone of the sealing valve 3, such that the opening degree of the sealing valve 3 matches the target opening degree. This configuration enables to control the flow rate of the vapor-phase gas G passing through the sealing valve 3 at an appropriate flow rate.

As shown in FIG. 6, the opening degree correction unit 56 uses the pressure relationship map M1 between the valve opening start amount K0 and the pressure P of the vapor phase gas G when performing both the vapor operation 501 and the purge operation 503. Then, the opening degree command amount K1 by the opening degree command unit 51 is corrected. When performing the vapor operation 501 and the purge operation 503, the opening degree correction unit 56 detects the in-operation pressure Pa, which is the pressure P of the vapor-phase gas G when the sealing valve 3 opens the vapor pipe 41, by using the pressure sensor 44.

Next, the opening degree correction unit 56 collates the in-operation pressure Pa to the pressure relationship map M1 and reads the operating valve opening amount Ka, which is the valve opening amount K0 corresponding to the in-operation pressure Pa. Next, when the opening degree command unit 51 transmits the opening degree command amount K1 to the stepping motor 35 of the sealing valve 3, the opening degree correction unit 56 adds the amount Ka to the opening degree command K1 in order to correct the opening degree command amount K1. In other words, the opening degree correction unit 56 changes the number of pulses indicated by the opening degree command amount K1 transmitted from the opening degree command unit 51 to the stepping motor 35 to a number of pulses obtained by adding the number of pulses corresponding to the opening degree command amount K1 to the number of pulses corresponding to the amount Ka.

In this way, as shown in FIG. 5, the opening degree correction unit 56 adds the operating valve opening start amount Ka to the opening degree command amount K1, which is based on a target opening degree X for the opening degree of the sealing valve 3, thereby to obtain a corrected opening degree command amount K2. Further, during the vapor operation 501 and the purge operation 503, when the vapor pipe 41 is opened by the sealing valve 3, the opening degree command unit 51 sends the corrected opening degree command amount K2 to the stepping motor 35 of the sealing valve 3, thereby to set the opening degree of the sealing valve 3.

(Control of Evaporated Fuel Processing Device 1)

As shown in FIG. 1, in the vehicle 6, when the control device 5 performs the sealing operation such that the opening degree of the sealing valve 3 is zero and the valve 33 closes the sealing passage 311 of the housing 31, the vapor pipe 41 that connects the fuel tank 62 to the canister 2 is closed. Then, the pressure P of the vapor-phase gas G in the fuel tank 62 is appropriately increased. Hereinafter, the learning operation 504, the vapor operation 501, the canister purge operation 502, and the purge operation 503 will be described with reference to flowcharts.

(Learning Operation 504)

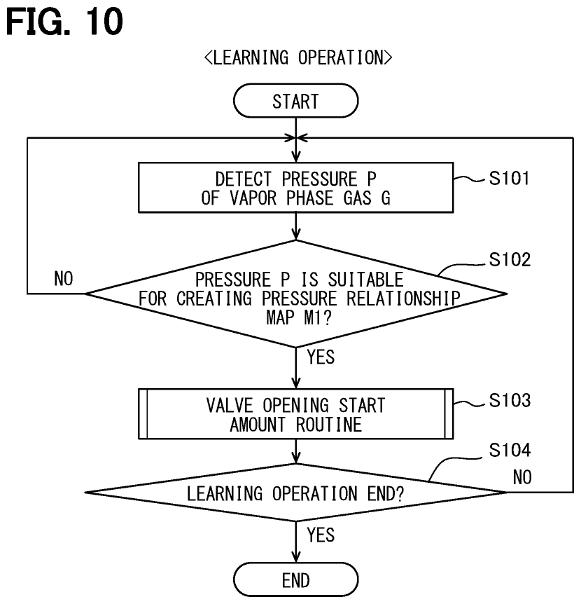

As shown in the flowcharts of FIG. 10, when the opening of the sealing valve 3 is zero, the control device 5 performs the learning operation 504. In the learning operation 504, the pressure sensor 44 detects the pressure P of the vapor-gas pressure G (step S101). Then, the relationship learning unit 55 of the control device 5 determines whether or not the detected pressure P of the vapor-phase gas G is suitable for creating the pressure relationship map M1 (step S102). This determination is performed to obtain the relationships between multiple values of the pressure P of the vapor-phase gas G and corresponding values of the valve opening start amount K0 for the pressure relationship map Ml.

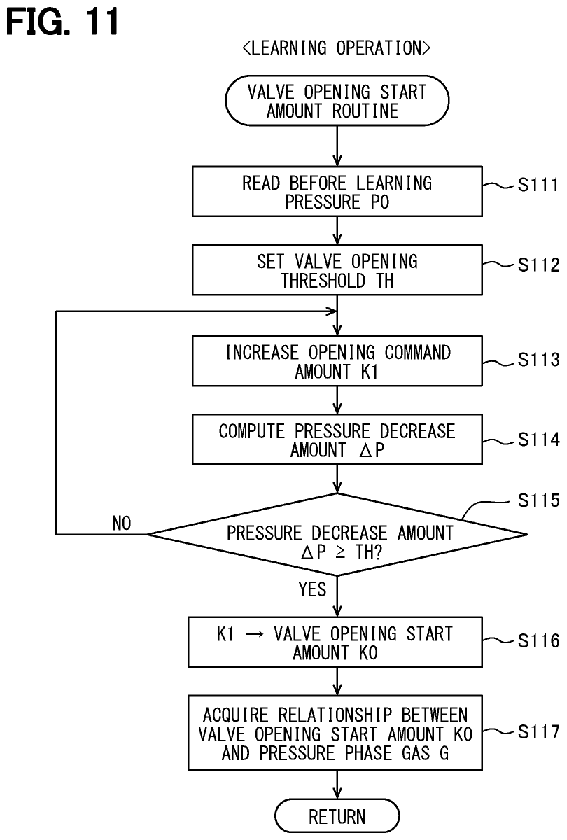

When the detected pressure P of the vapor-phase gas G is suitable for creating the pressure relationship map M1, a valve opening start amount routine is executed with the valve opening start learning unit 52 of the control device 5 (step S103). As shown in the flowchart of FIG. 11, in the valve opening start amount routine, first, the pressure P of the vapor-phase gas G, which is detected in a state where the opening degree command amount K1 of the opening degree command unit 51 of the control device 5 is set to zero, is read as the before-learning pressure P0. (Step S111). The pressure P of the vapor-phase gas G is, for example, the pressure P of the vapor-phase gas G detected in step S101. Next, the valve opening threshold set unit 53 of the control device 5 collates the before-learning pressure P0 with the threshold map M, thereby to set the valve opening threshold TH (step S112).

Subsequently, the opening degree command unit 51 of the control device 5 increases the opening degree command K1 by a predetermined amount (step S113). Subsequently, the pressure sensor 44 detects the pressure P of the vapor-gas pressure G (step S114), and the pressure decrease amount detection unit 54 of the control device 5 subtracts the pressure P of the vapor-phase gas G from the before-learning pressure P0 to calculate the pressure decrease ΔP (=P0 −P).

The valve opening start learning unit 52 of the control device 5 compares the pressure decrease amount ΔP with the valve opening threshold value TH and determines whether or not the pressure decrease amount ΔP is equal to or higher than the valve opening threshold value TH (step S115). When ΔP≥TH is satisfied, it is determined that the pressure P of the vapor-phase gas G has started to decrease, and the opening degree command amount K1 at this time is set as the valve opening start amount K0 (step S116). When ΔP<TH is satisfied, it is determined that the decrease in the pressure P of the vapor-phase gas G has not started yet. In this case, the opening degree command amount K1 is increased, and the pressure decrease amount ΔP is repeatedly compared with the valve opening threshold TH (step S113 to 115).

In this way, the valve opening start position is learned based on the pressure decrease amount ΔP of the pressure P of the vapor-phase gas G, and the relationship between the valve opening start amount K0 and the pressure P of the vapor-phase gas G is obtained as a part of the pressure relationship map M1 (step S117).

Subsequently, as shown in the flowchart of FIG. 10, the detection of the pressure P of the vapor-phase gas G by using the pressure sensor 44 is continued (step S101). In addition, the relationship learning unit 55 determines whether or not the detected pressure P of the vapor-phase gas G is suitable for creating the pressure relationship map M1 (step S102). Then, when multiple values of the different pressure P of the vapor-phase gas G are detected, the valve opening start amount routine is repeatedly performed (steps S103, S111 to S117).

In this way, until the learning operation 504 is completed (step S104), the relationship between the valve opening start amount K0 and the pressure P of the vapor-phase gas G is obtained in an appropriate range of the pressure P of the vapor-phase gas G (step S117), and the pressure relationship map M1 between the valve opening start amount K0 and the pressure P of the vapor-phase gas G is created.

(Vapor Operation 501)

An occupant of the vehicle 6 presses a refueling switch provided in the vehicle compartment prior to refueling the fuel tank 62 with the fuel F. The operation of the refueling switch is interpreted as the start of the vapor operation, and the vapor operation 501 is performed by the control device 5. At this time, the opening degree correction unit 56 uses the pressure relationship map M1 to correct the opening degree command amount K1 from the opening degree command unit 51.

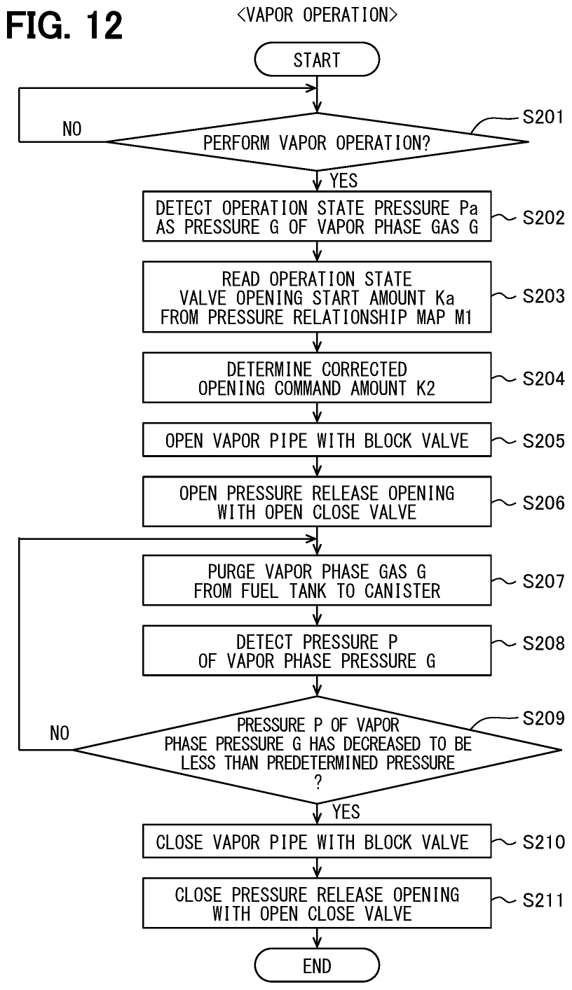

Specifically, as shown in the flowchart of FIG. 12, it is determined whether or not to perform the vapor operation 501 based on the presence or absence of the input of the refueling switch (step S201). When the refueling switch is pressed, an in-operation time is recognized, and the in-operation pressure Pa as the pressure P of the vapor-phase gas G in the in-operation time is detected by using the pressure sensor 44 (step S202).

Next, as shown in FIG. 6, the in-operation pressure Pa is collated with the pressure relationship map M1, and the in-operation valve opening start amount Ka, which is the valve opening start amount K0 corresponding to the in-operation pressure Pa, is read from the pressure relationship map M1 (step S203). Then, as shown in FIG. 5, the opening degree command amount K1 from the opening degree command unit 51 is used to calculate the corrected opening degree command amount K2 (step S204). Specifically, the corrected opening degree command amount K2 is calculated by adding the in-operation valve opening start amount Ka to the opening degree command amount K1 corresponding to the target opening degree. The target opening degree is determined according to a target flow rate for the vapor-phase gas G to be purged from the fuel tank 62 to the canister 2.

Next, the corrected opening degree command amount K2 is transmitted from the opening degree command unit 51 to the stepping motor 35 of the sealing valve 3, and the vapor pipe 41 is opened by using the sealing valve 3 (step S205). Further, in response to a command received from the control device 5, the pressure release port 213 is opened by the open/close valve 23 of the canister 2 (step S206). In this way, the vapor-phase gas G flowing through the sealing valve 3 is controlled to flow at the target flow rate, and the vapor-phase gas G is purged from the fuel tank 62 to the canister 2 through the vapor pipe 41 (step S207). At this time, the gas in the fuel tank 62 flows to the canister 2 due to the difference between the pressure P caused by the vapor-phase gas G and the like in the fuel tank 62 and the pressure in the canister 2. As a result, the fuel components of the evaporated fuel F1 contained in the vapor-phase gas G are adsorbed by the adsorbent 22 in the canister 2.

Thereafter, the pressure P of the vapor-phase gas G is detected by using the pressure sensor 44 (step S208), and it is determined whether or not the pressure P of the vapor-phase gas G has dropped below a predetermined pressure (step S209). When the pressure P of the vapor-phase gas G has dropped to the predetermined pressure or less, the vapor pipe 41 is closed by the sealing valve 3 (step S210). In addition, the pressure release port 213 of the canister 2 is closed by the open/close valve 23 (step S211). In this way, the vapor operation 501 is completed, and the fuel supply port 621 is opened by the control device 5 to enable an occupant of the vehicle 6 to supply fuel into the fuel tank 62 from the fuel supply port 621.

In addition, when an occupant of the vehicle 6 or the like supplies fuel F to the fuel tank 62, the sealing valve 3 may open the vapor pipe 41, and the open/close valve 23 may open the pressure release port 213 of the canister 2.

(Canister Purge Operation 502)

A canister purge operation 502 is a process in which, while the internal combustion engine 61 is performing the combustion operation, the fuel components adsorbed by the adsorbent 22 of the canister 2 are purged to the intake pipe 611 of the internal combustion engine 61. The timing at which the canister purge operation 502 is performed is appropriately determined by the control device 5.

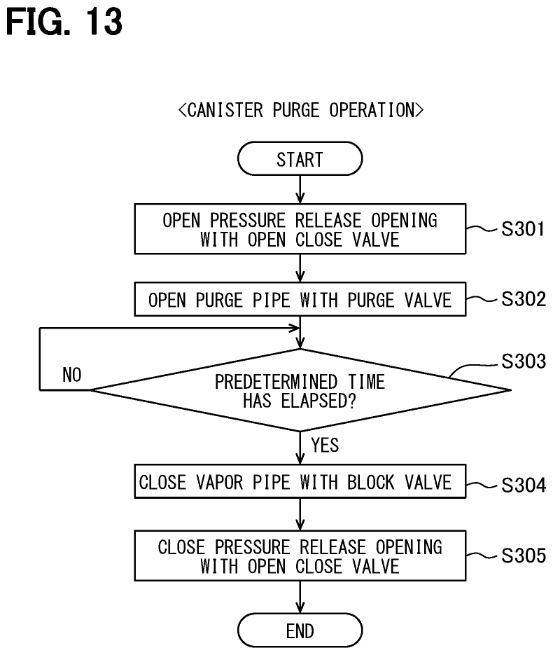

Specifically, as shown in the flowchart in FIG. 13, the fuel component adsorbed by the adsorbent 22 is purged from the canister 2 to the intake pipe 611 of the internal combustion engine 61, the pressure release port 213 of the canister 2 is opened by the open/close valve 23 (step S301), and the purge pipe 42 is opened by the purge valve 43 (step S302). At this time, the canister 2 is connected to the intake pipe 611 of the internal combustion engine 61 through the purge pipe 42. The fuel component in the adsorbent 22 flows to the intake pipe 611 due to the difference between the pressure in the canister 2 (atmospheric pressure) and the pressure in the intake pipe 611 (negative pressure) of the internal combustion engine 61. The fuel component released from the adsorbent 22 is used for the combustion of the internal combustion engine 61 together with the fuel F injected into the internal combustion engine 61.

Next, it is determined whether a predetermined time has elapsed since the open/close valve 23 and the purge valve 43 were opened (step S303). After the predetermined amount of time has elapsed, the pressure release port 213 of the canister 2 is closed by the open/close valve 23 (step S304), and the purge pipe 42 is closed by the purge valve 43 (step S305). In this way, the canister purge operation 502 is completed, and the fuel component adsorbed by the adsorbent 22 of the canister 2 is used for the combustion operation of the internal combustion engine 61.

(Purge Operation 503)

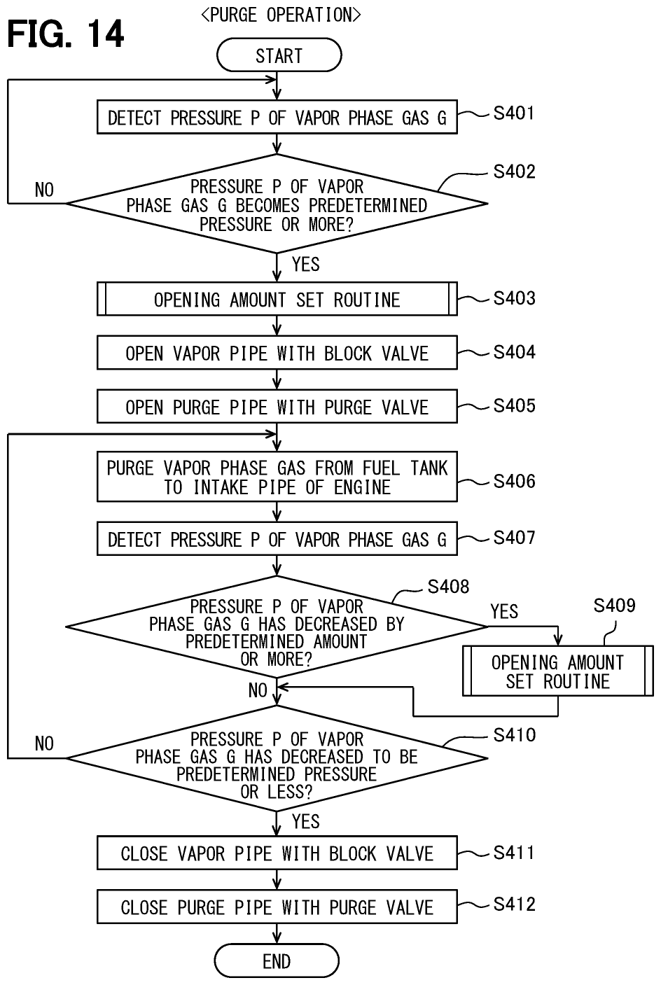

As shown in the flowchart of FIG. 14, while the internal combustion engine 61 is performing the combustion operation, the fuel tank 62 is normally closed by the sealing valve 3. In this state, the pressure sensor 44 of the fuel tank 62 continuously detects the pressure P of the vapor-phase gas G (step S401). In addition, it is determined whether or not the pressure P of the vapor-phase gas G has reached or exceeded a predetermined pressure (step S402). When the pressure P of the vapor-phase gas G reaches the predetermined pressure or more, it signals a purge operation time, and the purge operation 503 is executed by the control device 5.

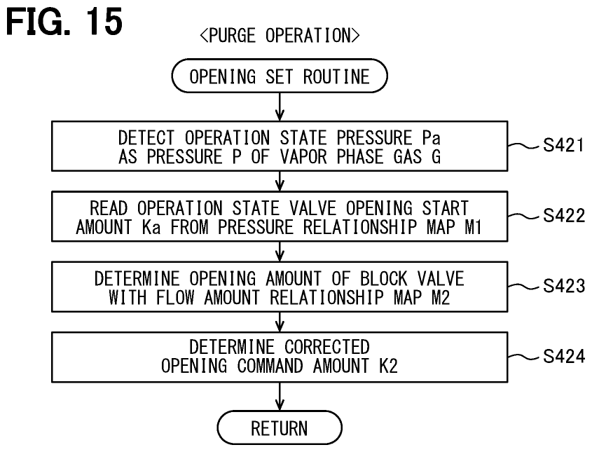

Specifically, an opening degree setting routine (step S403) is executed. As shown in the flowchart in FIG. 15, in the opening degree setting routine, the in-operation pressure Pa as the pressure P of the vapor-phase gas G in the in-operation time is detected by using the pressure sensor 44 (step S421). Next, as shown in FIG. 6, the in-operation pressure Pa is collated with the pressure relationship map M1, and the in-operation valve opening start amount Ka, which is the valve opening start amount K0 corresponding to the in-operation pressure Pa, is read from the pressure relationship map M1 (step S422).

Next, the opening degree of the sealing valve 3 for producing the target flow rate is determined based on the pressure P of the vapor-phase gas G and the target flow rate of vapor-phase gas G flowing through the sealing valve 3 (step S423). The target flow rate of the vapor-phase phase gas G flowing through the closed valve 3 is set to a flow rate suitable for controlling the air-fuel ratio of the internal combustion engine 61. Then, as shown in FIG. 5, the opening degree command amount K1 from the opening degree command unit 51 is used to calculate the corrected opening degree command amount K2 (step S424). Specifically, the corrected opening degree command amount K2 is calculated by adding the in-operation valve opening start amount Ka to the opening degree command amount K1 corresponding to the opening degree of the sealing valve 3.

Next, the corrected opening degree command amount K2 is transmitted from the opening degree command unit 51 to the stepping motor 35 of the sealing valve 3, and the vapor pipe 41 is opened by using the sealing valve 3 (step S404). Further, in response to a command received from the control device 5, the purge pipe 42 is opened by the purge valve 43 (step S405). Note that the vapor pipe 41 may be opened by the sealing valve 3 after the purge pipe 42 is opened by the purge valve 43. Further, when the purge pipe 42 is opened by the purge valve 43, the pressure release port 213 of the canister 2 may be opened by the open/close valve 23.

In this way, the vapor-phase gas G flowing through the sealing valve 3 and the purge valve 43 is controlled to flow at the target flow rate. The vapor-phase gas G in the fuel tank 62 is purged into the intake pipe 611 of the internal combustion engine 61 through the vapor pipe 41 and the purge pipe 42 (step S406). At this time, the gas in the fuel tank 62 flows to the intake pipe 611 of the internal combustion engine 61 due to the difference between the pressure caused by the vapor-phase gas G in the fuel tank 62 and the pressure in the intake pipe 611.

Further, the injected fuel F2 is supplied by the fuel injection device 63, and a feedback control is performed by the control device 5, such that the air-fuel ratio becomes the target air-fuel ratio, for the internal combustion engine 61 before the purge operation 503 and the canister purge operation 502 are performed to purge the vapor-phase gas G from the evaporative fuel processing device 1 to the intake pipe 611

Thereafter, the pressure P of the vapor-phase gas G is detected by using the pressure sensor 44 (step S407), and it is determined whether or not the pressure P of the vapor-phase gas G has dropped by a predetermined pressure or more (step S408). When the pressure P of the vapor-phase gas P has dropped by the predetermined amount or more, the opening degree setting routine (step S409) is executed again.

Thereafter, when the pressure P of the vapor-phase gas G is detected by using the pressure sensor 44, it is determined whether or not the pressure P of the vapor-phase gas G has dropped below a predetermined pressure (step S410). When the pressure P of the vapor-phase gas G becomes the predetermined pressure or less, the vapor pipe 41 is closed by the sealing valve 3 (step S411). Further, the purge pipe 42 is closed by the purge valve 43 (step S412). In this way, the purge operation 503 is completed, and the vapor-phase gas G generated in the fuel tank 62 is used for the combustion operation of the internal combustion engine 61.

(Pressure Relationship Map M1 Update and the Like)

In the present embodiment, the flowcharts (FIGS. 10 to 15) are shown in which the operations 501 to 504 by the control device 5 are performed separately. It is noted that, the present disclosure is not limited thereto. The learning operation 504 is not limited to being performed only prior to the vapor operation 501, the canister purge operation 502, and the purge operation 503. For example, the learning operation 504 may be continuously performed, including after the operations 501, 502, and 503 are performed. The learning operation 504 may be performed at an appropriate timing during the sealing operation of the control device 5 in which the fuel tank 62 is sealed by the sealing valve 3. In addition, the learning operation 504 may be performed between the vapor operation 501 and the canister purge operation 502, between the canister purge operation 502 and the purge operation 503, and between the purge operation 503 and the vapor operation 501.

Further, the vapor operations 501 or the purge operation 503 may be performed before the pressure relationship map M1 is created by the learning operation 504. In this case, the opening degree correction unit 56 may temporarily use a predefined relationship map initially set in the control device 5. Then, after the pressure relationship map M1 is generated by a subsequent learning operation 504, the created pressure relationship map M1 can be used. The pressure relationship map M1 may be appropriately updated each time the learning operation 504 is performed.

(Operation Effect)

The evaporative fuel processing device 1 of the present embodiment uses the pressure decrease amount ΔP from the before-learning pressure P0 when learning the valve opening start amount K0 when the stepping motor 35 is operated, and the sealing valve 3 actually opens the purge pipe 41. In this way, this configuration enables to reduce the influence of pressure pulsation and enables accurate learning and to appropriately correct the opening degree command amount K1 for determining the opening degree of the closed valve 3 by using the result. In addition, this configuration enables to learn the relationship between the multiple values of the valve opening start amount K0 and the multiple values of pressure P of the vapor-phase gas G corresponding to the multiple values of the before-learning pressures P0 and enables to create the pressure relationship map M1 between the valve opening start amount K0 and the pressure P of the vapor-phase gas G.

Therefore, the evaporative fuel processing device 1 of the present embodiment enables to control the sealing valve 3 at the target opening degree in the vapor operation 501 and the purge operation 503, thereby to enable to control the purge flow rate of the evaporated fuel F1 from the fuel tank 62 more appropriately and quantitatively when the evaporated fuel F1 is purged to the canister 2 and the intake pipe 611.

The present disclosure is not limited to each embodiment, and it is possible to configure further different embodiments without departing from the gist of the present disclosure. Further, the present disclosure includes various modifications, modifications within the equivalence, and the like. Furthermore, the technical idea of the present disclosure further includes various combinations and various forms of constitutional elements that are derivable from the present disclosure.

The controllers and methods described in the present disclosure may be implemented by a special purpose computer created by configuring a memory and a processor programmed to execute one or more particular functions embodied in computer programs. Alternatively, the controllers and methods described in the present disclosure may be implemented by a special purpose computer created by configuring a processor provided by one or more special purpose hardware logic circuits. Alternatively, the controllers and methods described in the present disclosure may be implemented by one or more special purpose computers created by configuring a combination of a memory and a processor programmed to execute one or more particular functions and a processor provided by one or more hardware logic circuits. The computer programs may be stored, as instructions being executed by a computer, in a tangible non-transitory computer-readable medium.

It should be appreciated that while the processes of the embodiments of the present disclosure have been described herein as including a specific sequence of steps, further alternative embodiments including various other sequences of these steps and/or additional steps not disclosed herein are intended to be within the steps of the present disclosure.

While the present disclosure has been described with reference to preferred embodiments thereof, it is to be understood that the disclosure is not limited to the preferred embodiments and constructions. The present disclosure is intended to cover various modification and equivalent arrangements. In addition, while the various combinations and configurations, which are preferred, other combinations and configurations, including more, less or only a single element, are also within the spirit and scope of the present disclosure.

What is claimed is:

1. An evaporated fuel processing device provided in a vehicle, which includes an internal combustion engine and a fuel tank, for processing evaporated fuel that is fuel evaporated in the fuel tank, comprising:
a canister including an adsorbent for adsorbing evaporated fuel;
a sealing valve provided in a vapor pipe that connects the fuel tank to the canister, the sealing valve configured to be operated by an actuator to quantitatively adjust an opening degree of the sealing valve to open and close the vapor pipe;
a pressure sensor provided in the fuel tank and configured to detect a pressure of vapor-phase gas in the fuel tank;
a purge valve provided in a purge pipe connecting the canister to an intake pipe of the internal combustion engine, the purge valve configured to open and close the purge pipe;
a control device (5) configured to selectively execute each of
a sealing operation to cause the sealing valve to close the vapor pipe to seal the fuel tank,
a vapor operation to cause the sealing valve to open the vapor pipe to purge the vapor-phase gas in the fuel tank into the canister,
a canister purge operation to cause the purge valve to open the purge pipe to purge a fuel component in the canister into the intake pipe,
a purge operation to cause the sealing valve to open the vapor pipe and at the same time to cause the purge valve to open the purge pipe to purge the vapor-phase gas in the fuel tank into the intake pipe by bypassing the canister, and
a learning operation to learn an opening degree of the sealing valve during at least one of the vapor operation or the purge operation, wherein
the control device includes
an opening degree command unit configured to transmit an opening degree command amount, which is for determining the opening degree of the sealing valve, to the actuator,
a valve opening start learning unit configured to learn a valve opening start amount in the learning operation based on the opening degree command amount when pressure of the vapor-phase gas starts to decrease in response to the opening degree command amount that gradually increases from zero and
a valve opening threshold set unit configured to set a valve opening threshold, which is for determining that the pressure of the vapor-phase gas has started to decrease, based on a before-learning pressure, which is the pressure of the vapor-phase gas before a time point when the learning operation is started, wherein
the control device is configured to determine the opening degree command amount of the opening degree command unit based on the valve opening start amount of the valve opening start learning unit when causing the sealing valve to open to perform the vapor operation or the purge operation.

2. The evaporated fuel processing device according to claim 1,
the control device includes a pressure decrease amount detection unit configured to detect a pressure decrease amount, which is a value obtained by subtracting the pressure of the vapor-phase gas, when the opening degree command amount gradually increases from zero, from the before-learning pressure, and
the valve opening start learning unit is configured to
perform the learning operation when the internal combustion engine is stopped or when an operation of the internal combustion engine is started and
determine that the pressure of the vapor-phase gas has started to decrease when the pressure decrease detected by using the pressure decrease amount detection unit becomes equal to or higher than the valve opening threshold value.

3. The evaporated fuel processing device according to claim 1, wherein
the valve opening threshold set unit is configured to set the valve opening threshold to a larger value, as the before-learning pressure becomes higher.

4. The evaporated fuel processing device according to claim 1, wherein
the control device includes a threshold map that shows a relationship between the before-learning pressure and the valve opening threshold and that is created by learning in advance a maximum value and a minimum value of a pressure pulsation waveform that changes depending on a magnitude of the before-learning pressure,
the valve opening threshold is set to a larger value in the threshold map, as a pulsation amount, which is a difference between the maximum value and the minimum value, becomes larger, and
the valve opening threshold set unit is configured to
read the valve opening threshold corresponding to the before-learning pressure with reference to the threshold map and
set the valve opening threshold.

5. The evaporated fuel processing device according to claim 4, wherein
the valve opening threshold set unit is configured to set a corrected threshold that is obtained by correcting the valve opening threshold, which is set with reference to the threshold map, based on at least one of environmental information inside the fuel tank or environmental information outside the fuel tank that is input to the control device.

6. The evaporated fuel processing device according to claim 1, wherein the control device includes
a relationship learning unit configured to
learn a relationship between a plurality of different values of the vapor-phase gas pressure and a plurality of different values of the valve opening start amount, which correspond to a plurality of different values of the before-learning pressure, when the valve opening start learning unit learns a plurality of different values of the valve opening start amount corresponding to a plurality of different values of the before-learning pressure in the learning operation and
create a relationship map between the valve opening start amount and the pressure of the vapor-phase gas pressure and
an opening degree correction unit configured to
collate an in-operation pressure, which is the pressure of the vapor-phase gas detected by using the pressure sensor, with the relationship map, when the sealing valve is opened to perform the vapor operation or the purge operation and
read an in-operation valve opening start amount, which is the valve opening start amount at this time, with reference to the relationship map and
correct the opening degree command amount of the opening degree command unit by using the in-operation valve opening start amount.

7. A control device for an evaporated fuel processing device provided in a vehicle, comprising:
a processor configured to selectively execute each of:
a sealing operation to cause an actuator to drive a sealing valve, which is provided in a vapor pipe connecting a fuel tank to a canister, to close the vapor pipe to seal the fuel tank, the canister including an adsorbent for adsorbing evaporated fuel, the actuator being configured to drive the sealing valve to quantitatively adjust an opening degree of the sealing valve for opening and closing the vapor pipe;
a vapor operation to cause the sealing valve to open the vapor pipe to purge the vapor-phase gas in the fuel tank into the canister,
a canister purge operation to cause a purge valve to open a purge pipe to purge a fuel component in the canister into an intake pipe of an internal combustion engine;
a purge operation to cause the sealing valve to open the vapor pipe and at the same time to cause the purge valve to open the purge pipe to purge the vapor-phase gas in the fuel tank into the intake pipe by bypassing the canister; and
a learning operation to learn an opening degree of the sealing valve during at least one of the vapor operation or the purge operation, wherein
the processor is further configured to:
transmit an opening degree command amount to the actuator to command the opening degree of the sealing valve;
learn a valve opening start amount in the learning operation based on the opening degree command amount when the pressure of the vapor-phase gas starts to decrease in response to the opening degree command amount that gradually increases from zero;
set a valve opening threshold, which is for determining that the pressure of the vapor-phase gas has started to decrease, based on a before-learning pressure, which is the pressure of the vapor-phase gas before a time point when the learning operation is started; and
determine the opening degree command amount of the opening degree command unit based on the valve opening start amount of the valve opening start learning unit when causing the sealing valve to open to perform the vapor operation or the purge operation.
